(19) United States
(12) Patent Application Publication
(10) Pub. No.: US 2007/0227908 A1
(43) Pub. Date: Oct. 4, 2007

(54) Electrochemical cell sensor

(75) Inventor: Ben E. Barnett, Dayton, OH (US)

Correspondence Address: THOMPSON HINE L.L.P.;Intellectual Property Group, P.O. BOX 8801, DAYTON, OH, 45401-8801, US

(73) Assignee: YSI, Inc.

(21) Appl. No.: 11/391,499

(22) Filed: Mar. 28, 2006

(51) Int. Cl. G01N 27/26

(52) U.S. Cl. 205/782.5; 204/415

(57) ABSTRACT

An apparatus for detecting the concentration of an analyte in a carrier including a housing having a working end, a membrane covering at least a portion of the working end, the membrane being substantially permeable to the analyte and substantially impermeable to the carrier, wherein the housing and the membrane define a chamber within the housing, an electrolyte solution disposed within the chamber, a tin anode disposed within the chamber and in contact with the electrolyte solution, and a cathode disposed within the chamber and in contact with the electrolyte solution.

### BACKGROUND

The present application relates to sensors and, more particularly, to electrochemical cell sensors for determining the concentration of a dissolved/dispersed analyte.

The measurement of the amount of gaseous oxygen dissolved in a volume of water is important in many applications including fish farming, waste water treatment and preventing corrosion and scale build-up in industrial boilers. Some dissolved oxygen sensors measure the partial pressure of oxygen in water, which is proportional to the amount of oxygen in the water (measured in milligrams per liter or parts per million).

A galvanic-type sensor for measuring dissolved oxygen typically includes a pair of electrodes (i.e., an anode and a cathode) immersed in an electrolyte solution within a sensor body. The electrode materials are selected such that the electromotive force or cell potential between the cathode and anode is greater than −0.5 volts, thereby eliminating the need for applying an external voltage (as is done with polarographic-type sensors). An oxygen permeable membrane typically is provided to separate the electrodes from the sample being measured.

Accordingly, as oxygen diffuses through the membrane, the oxygen is reduced at the cathode and a measurable electric current is generated within the cell. Higher oxygen concentrations in the sample results in more oxygen diffusing across the membrane, thereby producing more current. The current may be conducted through a thermistor to correct for permeation rate variation due to water temperature change such that the actual output from the galvanic sensor is a voltage.

Galvanic sensors may utilize lead anodes. However, because of the health risks associated with lead, such sensors typically incorporate zinc, rather than lead, anodes. Unfortunately, zinc anodes tend to exhibit significant unstable background current due to the higher voltage potential difference between the anode and the cathode.

Accordingly, there is a need for a galvanic sensor that does not exhibit significant unstable background current and does not have an electrode formed from lead.

### SUMMARY

In one aspect, the electrochemical cell sensor provides an apparatus for detecting the concentration of an analyte in a carrier including a housing having a working end, a membrane covering at least a portion of the working end, the membrane being substantially permeable to the analyte and substantially impermeable to the carrier, wherein the housing and the membrane define a chamber within the housing, an electrolyte solution disposed within the chamber, a tin anode disposed within the chamber and in contact with the electrolyte solution, and a cathode disposed within the chamber and in contact with the electrolyte solution.

In another aspect, the electrochemical cell sensor provides an apparatus for detecting dissolved oxygen in a liquid carrier including a housing having a working end, a membrane covering at least a portion of the working end, the membrane being substantially permeable to the oxygen and substantially impermeable to the liquid, wherein the housing and the membrane define a chamber within the housing, an electrolyte solution disposed within the chamber, a tin anode disposed within the chamber and in contact with the electrolyte solution, and a silver cathode disposed within the chamber and in contact with the electrolyte solution.

In another aspect, the electrochemical cell sensor provides a method for detecting dissolved oxygen in an aqueous liquid solution with a galvanic-type sensor including the steps of providing the sensor with a circuit having an anode including tin and a cathode including silver, positioning the anode and the cathode in an electrolyte solution, exposing the electrolyte solution to the dissolved oxygen such that the dissolved oxygen generates an electric current in the circuit, and monitoring the generated electric current.

Other aspects of the electrochemical cell sensor will become apparent from the following description, the accompanying drawings and the appended claims.

### BRIEF DESCRIPTION OF THE DRAWINGS

FIG. 1 is a front elevational view, partially in section, of one aspect of an electrochemical cell sensor according to the present invention; and

FIG. 2 is a graphical illustration of a voltammagram comparing a prior art sensor with the electrochemical cell according to the present invention.

### DETAILED DESCRIPTION

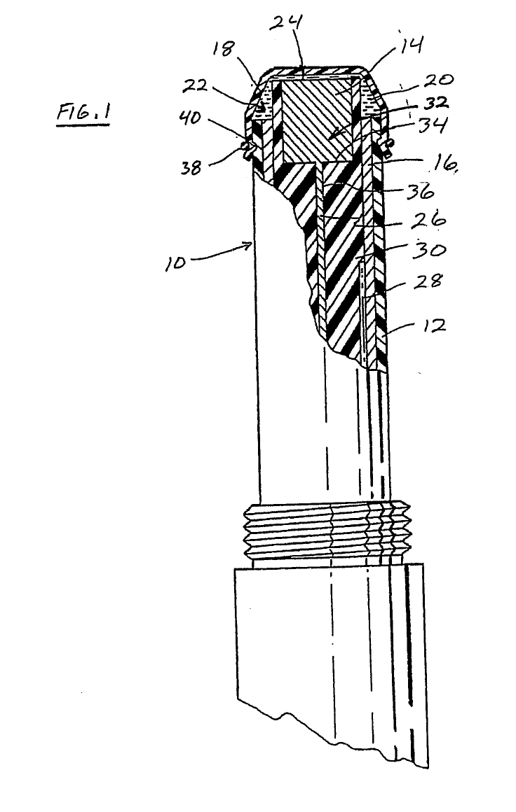

As shown in FIG. 1, a first aspect of the electrochemical cell sensor, generally designated 10, includes a sensor housing 12, a cathode 14, an anode 16, a membrane 18 and an electrolyte solution 20. The housing 12 and membrane 18 may define a chamber 22 near the working end 24 of the sensor 10. The cathode 14, the anode 16 and the electrolyte solution 20 may be positioned within the chamber 22.

The cathode 14 may be formed from and/or may include silver and may have a diameter of, for example, approximately 5 mm. A first lead 26 may be connected to the cathode 14. The anode 16 may be formed from and/or may include tin and may surround, at least partially, the cathode 14. A second lead 28 may be connected to the anode 16. The first and/or second leads 26, 28 may be connected to a processor, a monitoring device, an ammeter, a voltmeter or the like (not shown) such that an electrical signal may be monitored as analytes (e.g., oxygen) are reduced/oxidized at the electrodes (e.g., at the cathode).

The cathode 14 and the anode 16 may be at least partially separated and/or electrically insulated from each other by a spacer 30. The spacer 30 may be an epoxy or other polymeric material or the like capable of electrically insulating the cathode 14 from the anode 16. The spacer 30 may include a recess 32 having a shoulder 34 for positioning the cathode 14 near the working end 24 of the sensor 10. Furthermore, the spacer 30 may include a passageway 36 extending proximally from the shoulder 34 to accommodate the first lead 26.

The anode 16 may be electrically isolated from the surrounding sample medium (not shown) by the housing 12, which may be an epoxy or other polymeric or electrically insulating material.

At this point, those skilled in the art will appreciate that the sensor 10 may be any galvanic-type sensor having an anode and a cathode and may have various dimensions and structural configurations.

The membrane 18 may be a permeable or semi-permeable membrane and may be impervious to the electrolyte solution 20 and to the surrounding sample medium (e.g., the gas or liquid carrier), but may permit analytes (e.g., dissolved oxygen) to diffuse from the sample medium into the electrolyte solution 20. The membrane 18 may be formed from any appropriate membrane material such as, for example, a polyethylene or a polytetrafluoroethylene material. In one aspect, the membrane 18 may cover the working end 24 of the sensor 10 and may be secured to the housing 12 by an elastic ring 38 positioned within a groove 40. In another aspect (not shown), the sensor 10 may not include a membrane 18 or an electrolyte solution 20, leaving the cathode 14 and anode 16 directly exposed to the sample medium.

The electrolyte solution 20 may be disposed within the cavity 22 and may be in direct contact with the cathode 14 and the anode 16. The electrolyte solution 20 may include an aqueous solution of various salts, such as chloride salts or the like. For example, the electrolyte solution 20 may include an aqueous solution of about 0.1 M to about 1.5 M potassium chloride.

Accordingly, when the sensor 10 is exposed to a sample medium containing, for example, dissolved oxygen, the oxygen may diffuse through the membrane 18 and into the electrolyte solution 20 at a rate proportional to the oxygen concentration in the sample medium. Without being limited to any particular theory, it is believed that the diffused oxygen migrates to the cathode 14, where the oxygen is reduced, forming hydroxide ions. The hydroxide ions may then oxidize the tin anode, forming free electrons. The free electrons may be transported from the cathode 14 to the anode 16, thereby generating an electric current. The amount of electric current generated may be correlated to the oxygen concentration in the sample medium to provide the user with a usable measurement of dissolved oxygen concentration.

### EXAMPLE

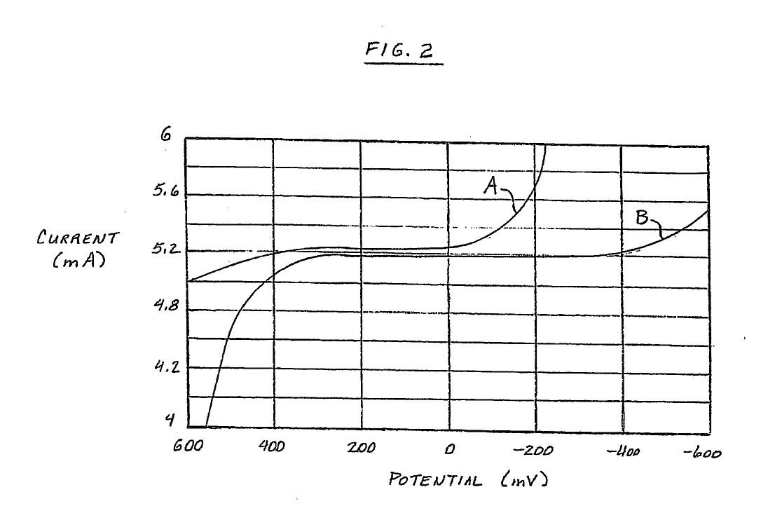

Electric current was conducted across two different sensors as a function of voltage applied between the cathode and anode of each sensor. The two sensors were tested in water-saturated air (21% oxygen). The electrolyte solution in each sensor was a potassium chloride aqueous solution. As shown in FIG. 2, curve A represents a sensor having a silver cathode and a zinc anode (i.e., a prior art sensor) and curve B represents a sensor having a silver cathode and a tin anode (i.e., a sensor according to an aspect of the present invention). Each curve includes a portion in which the current flow is an approximately linearly increasing function of voltage followed by a section in which the current is approximately constant at a reduction plateau despite increasing voltage.

The primary defining property of a galvanic-type sensor is that it operates with zero externally applied potential. For best sensor stability, this potential should be near the center of the current plateau where current is proportional to oxygen partial pressure.

In FIG. 2, curve B (i.e., silver cathode/tin anode) produces a current plateau that has minimal slope around zero potential, while curve A (i.e., silver cathode/zinc anode) produces a current plateau that curves upward at zero potential.

Accordingly, the sensors of the present invention provide a more stable background current during operation then similar sensors having a silver cathode and a zinc anode. In addition, the sensors of the present invention avoid the health hazards associated with electrodes formed from lead. Therefore, the sensors of the present invention may be well-suited for the continuous or semi-continuous measurement of dissolved oxygen and other analytes in various environments such as lakes, streams, industrial tanks or wastewater treatment plants.

Although the electrochemical cell sensor is shown and described with respect to certain aspects, modifications may occur to those skilled in the art upon reading the specification. The electrochemical cell sensor includes all such modifications and is limited only by the scope of the claims.

What is claimed is:

1. An apparatus for detecting the concentration of an analyte in a carrier comprising:
a housing having a working end;
a membrane covering at least a portion of said working end, said membrane being substantially permeable to said analyte and substantially impermeable to said carrier, wherein said housing and said membrane define a chamber within said housing;
an electrolyte solution disposed within said chamber;
a tin anode disposed within said chamber and in contact with said electrolyte solution; and
a cathode disposed within said chamber and in contact with said electrolyte solution.

2. The apparatus of claim 1 wherein said anode and said cathode are electrically connected to a monitoring device.

3. The apparatus of claim 1 wherein said electrolyte solution is an aqueous solution including a chloride salt.

4. The apparatus of claim 3 wherein said chloride salt is at least one of potassium chloride and sodium chloride.

5. The apparatus of claim 1 wherein said electrolyte solution is about 0.1 M to about 1.5 M aqueous potassium chloride.

6. The apparatus of claim 1 wherein said membrane is a semipermeable membrane.

7. The apparatus of claim 6 wherein said semipermeable membrane includes at least one of a polyethylene material and a polytetrafluoroethylene material.

8. The apparatus of claim 1 wherein said analyte is oxygen.

9. The apparatus of claim 1 wherein said cathode includes silver.

10. An apparatus for detecting dissolved oxygen in a liquid comprising:
a housing having a working end;
a membrane covering at least a portion of said working end, said membrane being substantially permeable to said oxygen and substantially impermeable to said liquid, wherein said housing and said membrane define a chamber within said housing;
an electrolyte solution disposed within said chamber;
a tin anode disposed within said chamber and in contact with said electrolyte solution; and
a silver cathode disposed within said chamber and in contact with said electrolyte solution.

11. The apparatus of claim 10 wherein said anode and said cathode are electrically connected to a monitoring device.

12. The apparatus of claim 10 wherein said electrolyte solution is an aqueous solution including a chloride salt.

13. The apparatus of claim 12 wherein said chloride salt is at least one of potassium chloride and sodium chloride.

14. The apparatus of claim 10 wherein said electrolyte solution is about 0.1 M to about 1.5 M aqueous potassium chloride.

15. The apparatus of claim 10 wherein said membrane is a semipermeable membrane.

16. The apparatus of claim 15 wherein said semipermeable membrane includes at least one of a polyethylene material and a polytetrafluoroethylene material.

17. A method for detecting dissolved oxygen in a liquid with a galvanic-type sensor comprising the steps of:
providing said sensor with an anode including tin and a cathode including silver;
positioning said anode and said cathode in an electrolyte solution;
exposing said electrolyte solution to said dissolved oxygen such that said dissolved oxygen generates an electric current in a circuit between said anode and said cathode; and
monitoring said electric current.

18. The method of claim 17 further comprising the step of correlating said electric current to a dissolved oxygen concentration.

19. The method of claim 17 wherein said electrolyte solution includes an aqueous solution including a chloride salt.

20. The method of claim 17 wherein said cathode reduces said dissolved oxygen.
